(19) United States
(12) Patent Application Publication
(10) Pub. No.: US 2025/0228749 A1
(43) Pub. Date: Jul. 17, 2025

(54) Infant Pacifier

(71) Applicant: Patrice E. Gray, Millersburg, OH (US)

(72) Inventor: Patrice E. Gray, Millersburg, OH (US)

(21) Appl. No.: 18/413,672

(22) Filed: Jan. 16, 2024

(51) Int. Cl. A61J 17/00

(52) U.S. Cl. CPC A61J 17/107

(57) ABSTRACT

The invention relates to a pacifier designed to soothe infants, particularly those who are breastfed, by mimicking the natural contours of an infant's mouth. The pacifier is shaped to accommodate the palate, tongue, and teeth alignment, reducing the risk of teeth misalignment, palate deformation, and weakened tongue muscles. The optimized shape facilitates easier sucking and reduces crying and fussiness. The design also helps minimize nipple confusion, making it suitable for breastfeeding mothers. The unique nipple design can be adapted for use in baby bottle nipples, offering potential for future innovation in infant care.

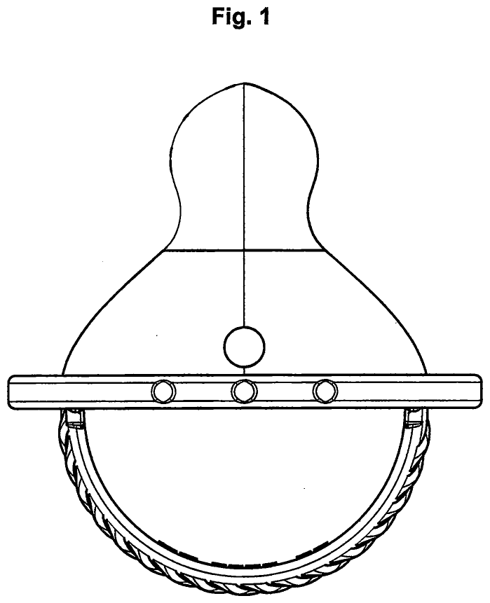

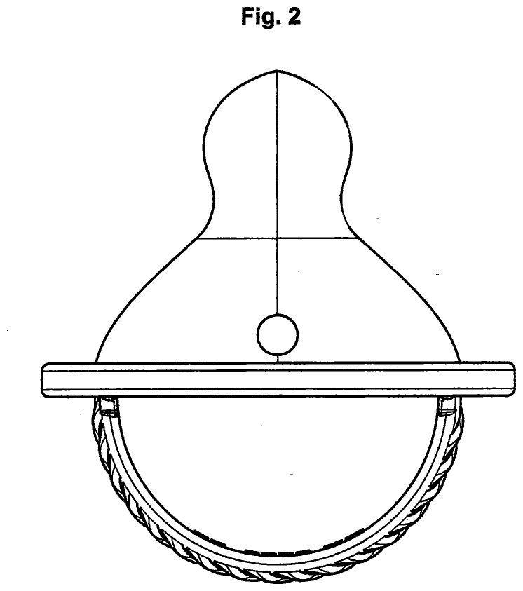

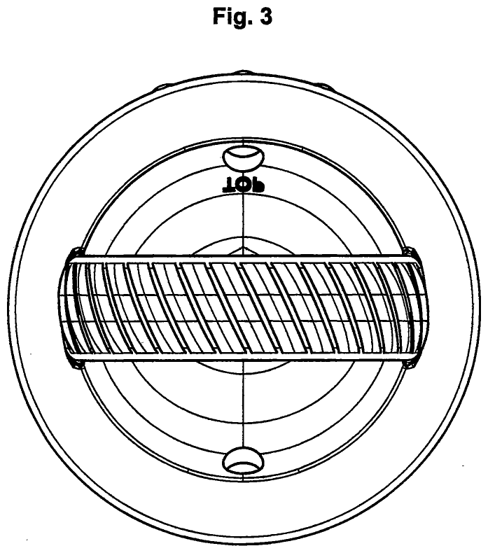

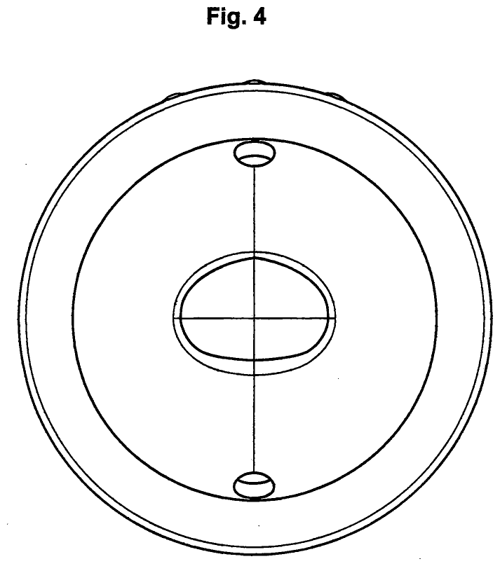

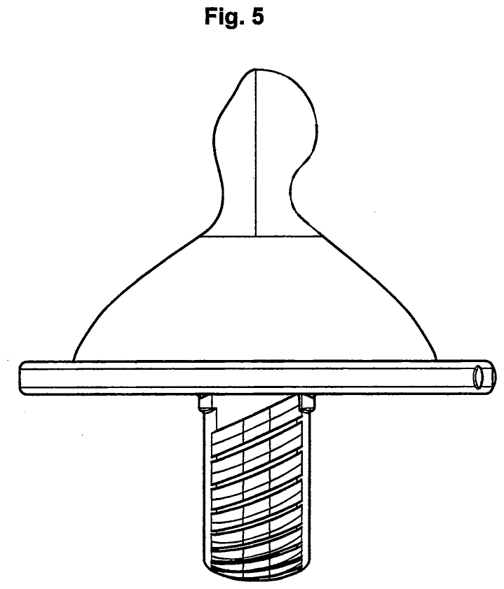

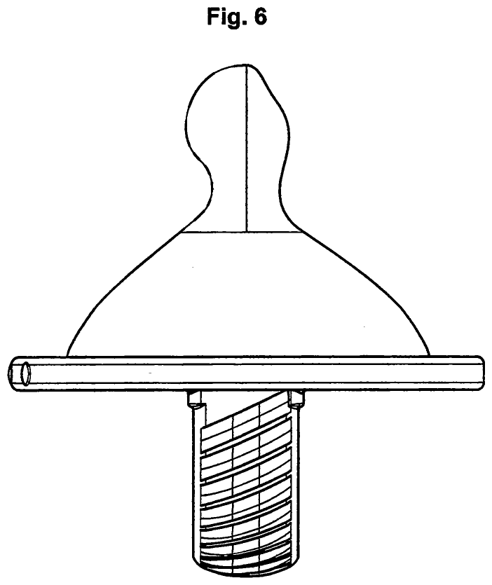

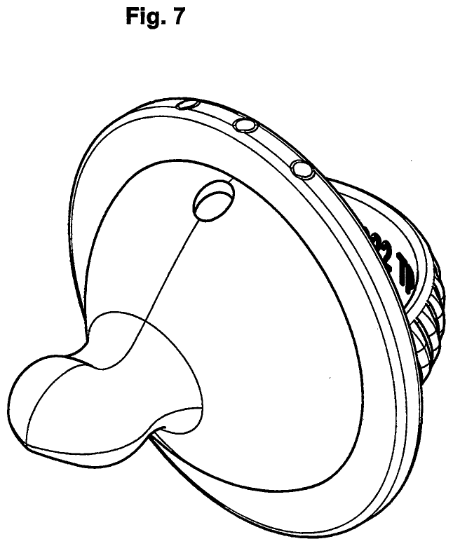

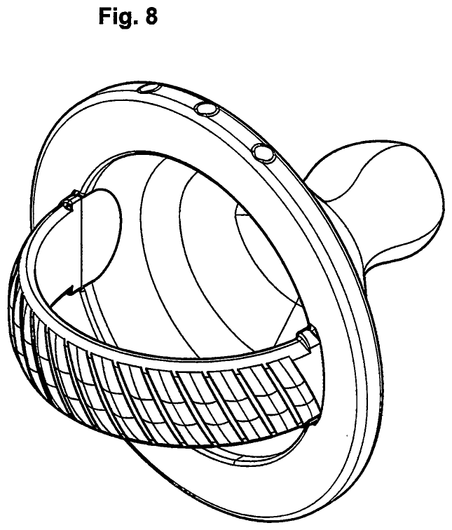

The problem being solved is uncontented infants. Extra sucking for breastfed infants is needed. This new shape of infant pacifier allows the infant to easily suck so less crying and fussiness occurs. This new improved shape is made to replicate the infant mouth, taking into consideration the palate, Tongue and teeth alignment compared to all other pacifiers on the market. Other pacifiers are Designed with poor adaptive configuration, not fitting the natural oral shape. All other pacifiers Could cause teeth misalignment along with palate deformation and possibly causing weak tongue muscles.

This new pacifier has been shaped to help breastfed crying infants to fill extra sucking needs. By placing the pacifier into the open mouth of an infant when crying or fussy, the Pacifier could be sucked on therefore providing the necessary comfort. This invention was made With the need in mind, drawings made, molds devised producing the end silicone made product. The Original samples were tested on many infants for approval. This nipple design could also be used for Baby bottle nipple design in the future.

1. A pacifier device comprising: a contoured mouth shield made of food-grade silicone, designed to fit comfortably against an infant's face; an ergonomic nipple designed to support oral development by mimicking natural nursing patterns; and a safety guard integrated into the mouth shield, ensuring secure use and preventing choking hazards.
